(19) United States
(12) Patent Application Publication
(10) Pub. No.: US 2026/0257941 A1
(43) Pub. Date: Sep. 3, 2026

(54) WATER PURIFIER

(71) Applicant: COWAY CO., LTD., Chungcheongnam-do (KR)

(72) Inventors: Si Jun PARK, Seoul (KR); Hyun Suk MOON, Seoul (KR); Woong JUNG, Seoul (KR); Min Su SONG, Seoul (KR); Chang Seob YEOM, Seoul (KR)

(73) Assignee: COWAY CO., LTD., Chungcheongnam-do (KR)

(21) Appl. No.: 19/655,560

(22) Filed: Apr. 22, 2026

Related U.S. Application Data
(63) Continuation-in-part of application No. PCT/KR2024/008507, filed on Jun. 20, 2024.

(30) Foreign Application Priority Data
Oct. 23, 2023 (KR) 10-2023-0141986
Dec. 8, 2023 (KR) 10-2023-0177882

(51) Int. Cl. C02F 1/00

(52) U.S. Cl. CPC C02F 1/003; C02F 2201/004; C02F 2201/005; C02F 2209/02; C02F 2307/10

(57) ABSTRACT

The present disclosure relates to a water purifier. Specifically, according to an embodiment of the present disclosure, a water purifier may be provided, including: a water purifier main body configured such that at least a part thereof is opened; a filter unit for filtering raw water to provide purified water; a flow channel providing a passage through which the raw water and the purified water flow; a valve unit including at least one valve module that is selectively opened and closed to regulate the flow of the raw water and the purified water; a sensor unit for measuring state information of the water and disposed within the water purifier main body; a reservoir in which an inlet for receiving water from an external water supply source, an outlet for discharging the received water to the outside, and a sensor hole into which the sensor unit is insertable are formed; and an ambient air inlet passage providing a path for ambient air to flow into the reservoir, wherein the valve unit includes an ambient air valve for selectively opening and closing the ambient air inlet passage, and wherein when at least a part of the water purifier main body is opened such that the sensor unit is exposed, the ambient air inlet passage is closed by the ambient air valve to prevent internal air from directly communicating with external air.

### TECHNICAL FIELD

The present disclosure relates to a water purifier.

### BACKGROUND OF THE INVENTION

Generally, a water purifier is a device receiving water from a water supply source such as a faucet, filtering the water into purified water through a filter provided therein, and then providing the purified water to a user. Furthermore, the purified water may be provided to the user as cold water cooled to a preset temperature or lower, or hot water heated to a preset temperature or higher by the water purifier.

Repair or part replacement of a water purifier was performed by a service technician who visits regularly, or by a service technician who visits when a malfunction of the water purifier is reported. However, recently, there has been an increasing demand for water purifiers allowing a user to directly replace a malfunctioning part without going through a service technician.

A water purifier requires control of various parts to provide purified water, and a sensor for such control may be required. For example, since the water purifier is operable to heat or cool purified water to provide the purified water at a user-desired temperature, the water purifier includes a temperature sensor to measure the temperature of the heated or cooled water. The water purifier may sense the temperature of hot water or cold water via a temperature sensor before the water is dispensed. In another embodiment, the water purifier may include a water level sensor to measure the water level of stored water to prevent the purified water from overflowing or running out. As described above, since the demand for self-maintenance has been increasing, for more components for self-maintenance, there is a need for the sensor, which is one of the components requiring replacement, to be easily self-detachable.

However, in a conventional water purifier, a sensor is integrally formed with a tank or a flow channel, or is arranged to be detachable only after disassembling other components such as the flow channel, which poses a problem in that the sensor is not easy to detach from the water purifier. For example, a temperature sensor is coupled to a tank or the like by a screw, which had an inconvenience in that a user is required to detach the screw before the temperature sensor is detached. Furthermore, when the temperature sensor is detached, water in the tank or the flow channel may leak to the outside, which posed a problem in that the sensor had to be detached after discharging the water in the tank or the flow channel before the temperature sensor was detached.

In this regard, Korean Registered Patent Publication No. 10-2022-0166395, titled “Stand-type Water Purifier” (Patent Document 1), filed by the applicant of the present disclosure, discloses a water purifier including a humidifying water tank temperature sensor, a cold water temperature sensor, and a hot water temperature sensor.

In Patent Document 1, the humidifying water tank temperature sensor is disposed in a humidifying water tank, the cold water temperature sensor is disposed inside a cold water generator, and the hot water temperature sensor is disposed inside a hot water generator. However, the humidifying water tank, the cold water generator, and the hot water generator are all arranged in a complex manner with other water purifier parts such as a water purification filter, an air flow channel, and a heater inside a housing, which poses a problem in that it is difficult for a user to easily replace them. In other words, in a water purifier such as that of Patent Document 1, a user may access the temperature sensor only after other components are disassembled, which poses a problem in that the detachment of the temperature sensor is not easy. In other words, in the water purifier of Patent Document 1, there is a problem in that detachment of other components is required to precede the detachment of the temperature sensor. In the case of Patent Document 1, there was a problem in that it was difficult for a user to easily detach and replace the temperature sensor by oneself.

Meanwhile, among the various parts of a water purifier, a display exposed to the outside may also malfunction. In conventional water purifiers, since the display is tightly coupled to a housing or a frame, there was a problem in that it was difficult for a user to directly replace the display. In other words, when the display malfunctions, there was a problem in that a user is required to use the water purifier with the display broken until a service technician visits.

In this regard, Korean Patent Application Publication No. 10-2019-0000065, titled “Water Purifier with Ice-Making Function and Operating Method Thereof” (Patent Document 2), filed by the applicant of the present disclosure, discloses a configuration in which a display is disposed on a front surface of a water purifier. Patent Document 2 discloses a configuration in which a display unit of the water purifier displays information related to function settings or information related to a power-saving function. However, Patent Document 2 does not disclose that the display may be easily detached from the main body. In other words, the display of Patent Document 2 is tightly fastened to the main body, which poses a problem in that it is difficult for a user to directly detach or replace it.

Furthermore, Korean Patent Application Publication No. 10-2016-0039019, titled “Coffee Extracting Water Purifier and Method for Removing Residual Water Thereof” (Patent Document 3), filed by the applicant of the present disclosure, discloses a configuration displaying information related to the operation or control of a coffee extracting water purifier. However, Patent Document 3 does not disclose that the display may be easily detached from the main body. In other words, the display of Patent Document 3 is tightly fastened to the main body, which poses a problem in that it is difficult for a user to directly detach or replace it. A user has the inconvenience of having to request repair service from a service technician who visits the home when needed or on a regular basis.

Furthermore, Korean Patent Application Publication No. 10-2019-0036297, titled “IoT-based Water Purifier and Information Synchronization Method Thereof” (Patent Document 4), filed by the applicant of the present disclosure, discloses a configuration in which drinking information about a user is displayed through a display unit when a user terminal is recognized. However, Patent Document 4 does not disclose that the display may be easily detached from the main body. In other words, the display of Patent Document 4 is tightly fastened to the main body, which poses a problem in that it is difficult for a user to directly detach or replace it for repair.

Meanwhile, since a front part of a water purifier is a part most easily accessible by a user, it has been common for the water purifier to have a filter, which needs periodic replacement, disposed in the front part area. However, because the display is disposed on the front part, there is a problem in that replaceable modules such as a replaceable flow channel module or a valve module for easy self-management may not be disposed on the front part of the water purifier. Furthermore, such a replaceable flow channel module or valve module was often disposed near a dispensing part where flow channels were concentrated, and since the display unit is disposed near the dispensing part, there was a problem in that the placement of the flow channel module or valve module became more difficult.

### PRIOR ART DOCUMENTS

### Patent Documents

(Patent Document 1) Korean Registered Patent Publication No. 10-2022-0166395 (Published on Dec. 19, 2022)

(Patent Document 2) Korean Patent Application Publication No. 10-2019-0000065 (Published on Jan. 02, 2023)

(Patent Document 3) Korean Patent Application Publication No. 10-2016-0039019 (Published on Apr. 08, 2016)

(Patent Document 4) Korean Patent Application Publication No. 10-2019-0036297 (Published on Apr. 04, 2019)

### DETAILED DESCRIPTION OF INVENTION

### Technical Problems

Embodiments of the present disclosure have been invented in view of the above background, and are intended to provide a water purifier including a sensor which may be more easily self-replaced by a user, and in which a display unit on a front of a main body may be more easily replaced so that the user to replace internal parts of the water purifier.

### Technical Solution

A water purifier according to one aspect of the present disclosure includes: a water purifier main body configured such that at least a part thereof is opened; a filter unit for filtering raw water to provide purified water; a flow channel providing a passage through which the raw water and the purified water flow; a valve unit including at least one valve module that is selectively opened and closed to regulate the flow of the raw water and the purified water; a sensor unit for measuring state information of the water and disposed within the water purifier main body; a reservoir in which an inlet for receiving water from an external water supply source, an outlet for discharging the received water to the outside, and a sensor hole into which the sensor unit is insertable are formed; and an ambient air inlet passage providing a path for ambient air to flow into the reservoir, wherein the valve unit includes an ambient air valve for selectively opening and closing the ambient air inlet passage, wherein when at least a part of the water purifier main body is opened such that the sensor unit is exposed, the ambient air inlet passage is closed by the ambient air valve to prevent internal air from directly communicating with external air.

Furthermore, the water purifier may further include a body cover unit covering at least one of the filter unit, the flow channel, and the valve unit, and the sensor unit may be detachably supported by the body cover unit.

Furthermore, the water purifier may further include: a display unit displaying at least one of a type of water discharged to the outside, an amount of the discharged water, and a temperature of the discharged water, and detachably supported by the water purifier main body; a detachment detection sensor detecting at least one of the detachment of the display unit from the water purifier main body and at least the part of the water purifier main body to be opened; and a controller controlling the opening and closing of the valve unit, wherein the controller, when the detachment of the display unit from the water purifier main body or at least the part of the water purifier main body is detected to be opened by the detachment detection sensor, closes the ambient air valve to prevent an ambient air from flowing into the reservoir through the ambient air inlet passage.

Furthermore, the sensor unit may include: a temperature sensor for measuring the temperature of the water; and a sensor holder for supporting the temperature sensor, and a hook configured to receive a user's finger is formed on the sensor holder.

Furthermore, the water purifier may further include: a reservoir in which an inlet for receiving water from an external water supply source and an outlet for discharging the received water to the outside, and a sensor hole into which the sensor unit is insertable are formed; and a sensor packing disposed in the sensor hole, wherein when the sensor unit is supported by the body cover unit, the sensor unit is inserted into the sensor hole to sense the temperature of the water in the reservoir, and wherein the sensor packing may restrict water in the reservoir from being discharged through the sensor hole when the sensor unit is detached from the body cover unit.

Furthermore, the body cover unit may further include: a fixed body cover part fixed to the water purifier main body; an opening body cover part rotatable with respect to the fixed body cover part; and a lever selectively preventing the sensor unit from being detached from the fixed body cover part, and a sensor body, which is a space for accommodating at least a portion of the sensor unit when the sensor unit is supported, may be formed in the fixed body cover part.

Furthermore, the lever may prevent the sensor unit from being detached from the fixed body cover part when disposed in an up-down direction.

Furthermore, the valve unit may further include an inlet valve for selectively opening and closing the inlet and an outlet valve for selectively opening and closing the outlet, and wherein the reservoir may be configured such that when the inlet valve or the outlet valve is opened, the ambient air inlet passage is opened by the ambient air valve to allow internal air to communicate with external air.

Furthermore, the water purifier may further include a display unit displaying at least one of a type of water discharged to the outside, an amount of the discharged water, and a temperature of the discharged water, and is detachably supported on the main body.

Furthermore, the water purifier may further include a screw for securing the display unit to the main body, wherein a main body latching part is formed on the main body, wherein a display latching part engaging with the main body latching part is formed on the display unit, and wherein the screw may be fastened to secure the display unit to the main body while the display latching part is engaged with the main body latching part.

Furthermore, the water purifier may further include: a controller that controls at least one of the valve unit and the display unit; and a body cover unit disposed inward of the display unit to cover at least one of the flow channel, the valve unit, and the controller, wherein the body cover unit may be exposed to the outside when the display unit is detached from the housing of the water purified main body.

Furthermore, the body cover may include: a fixed body cover part fixed to the main body; and an opening body cover part disposed inward of the display unit and rotatable with respect to the fixed body cover part to expose at least one of the flow channel, the valve unit, and the controller to the outside.

Furthermore, the display unit may include: a display panel displaying at least one of the type of water discharged to the outside, the amount of the discharged water, and the temperature of the discharged water; and a display housing covering the display panel, and wherein the controller may include: a main controller disposed within the main body to control the valve unit to regulate the flow of raw water and purified water within the flow channel; and a display controller disposed within the display housing to control the display panel, and wherein the display housing may cover the display panel and the display controller such that the display panel and the display controller are not exposed to the outside when the display unit is detached from the main body.

Furthermore, a molding part may be provided on an inner surface of the display housing to prevent water from flowing into the display panel when the display unit is detached from the main body.

Furthermore, the controller may include: a main controller disposed within the main body to control the valve unit to regulate the flow of raw water and purified water within the flow channel; and a control port connected to the main controller and electrically connecting the main controller with the outside, and the control port may be taken out to the exterior through a space opened when the opening body cover part is opened.

### Effect of Invention

Embodiments of the present disclosure have an effect that when a portion of a housing of the water purifier main body on which the display unit is formed is detached, the body cover is exposed, and the sensor unit is detachably supported by the body cover, so that a user may easily replace the sensor unit by detaching the portion of the housing.

Furthermore, embodiments of the present disclosure have an effect that since a sensor holder is formed on the sensor unit, a user may more easily detach the sensor unit from the body cover.

Furthermore, embodiments of the present disclosure have an effect that because the reservoir is provided as a sealed type, water leakage may be prevented when the sensor is detached from the reservoir.

Furthermore, embodiments of the present disclosure have an effect that since a sensor packing is provided, the sensor packing may block the sensor hole to prevent water leakage when the sensor is detached from the reservoir.

Furthermore, embodiments of the present disclosure have an effect that the sensor unit includes a lever, and the lever may switch the sensor unit with respect to the body cover to a fixed state or a detachable state.

Furthermore, embodiments of the present disclosure have an effect that the display unit is detachably supported by the main body, so that the display unit may be easily detached by a user.

Furthermore, embodiments of the present disclosure have an effect that the display unit disposed on a front of the water purifier is provided to be detachably separable, and replaceable parts such as a replaceable flow channel or a replaceable valve module are disposed to be exposed to the outside when the display unit is detached, allowing a user to easily access the replaceable parts.

Furthermore, embodiments of the present disclosure have an effect that the display unit may be easily temporarily fastened to the main body when the main body latching part formed on the main body and the display latching part formed on the display unit are engaged.

Furthermore, embodiments of the present disclosure have an effect that the display unit may be brought to a completely fastened state using a screw to prevent the display unit from being separated while temporarily fastened to the main body.

Furthermore, embodiments of the present disclosure have an effect that a body cover is provided when the display unit is opened, and the body cover includes an opening body cover part, so that a user may easily replace parts needing replacement inside the main body by opening the opening body cover part.

Furthermore, embodiments of the present disclosure have an effect that the display controller for controlling the display unit is disposed within the display housing and may be easily replaced or repaired by a user, and the control port connected to the main controller may be taken out to the exterior when the opening body cover part is opened, thereby being easily exposed to the user.

### BRIEF DESCRIPTION OF THE DRAWINGS

FIG. 1 is a perspective view of a water purifier according to an embodiment of the present disclosure.

FIG. 2 is an exploded perspective view of FIG. 1.

FIG. 3 is a cross-sectional view taken along line I-I of FIG. 1.

FIG. 4 shows a state in which a display unit is detached from FIG. 1.

FIG. 5 is a cross-sectional view taken along line II-II of FIG. 1.

FIG. 6 is an enlarged perspective view of portion A of FIG. 5.

FIG. 7 is a right side view of FIG. 6.

FIG. 8 is an enlarged view of portion B of FIG. 2.

FIG. 9 is a cross-sectional view taken along line III-III of FIG. 1.

FIG. 10 is a cross-sectional view taken along line IV-IV of FIG. 1.

FIG. 11 is a perspective view showing a state in which a sensor unit is detached from a body cover.

FIG. 12 is a perspective view of a display unit and a front part of a main body according to an embodiment of the present disclosure.

FIG. 13 is an enlarged perspective view of a main body latching part after detaching the display unit.

FIG. 14 is an enlarged view of portion C of FIG. 12.

FIG. 15 is an enlarged view of portion D of FIG. 12.

FIG. 16 is a rear perspective view of FIG. 15.

FIG. 17 is a perspective view showing that an opening body cover part is rotatable.

FIG. 18 is a front view of a state in which an opening body cover part is opened according to an embodiment of the present disclosure.

FIG. 19 is a perspective view of a state in which a display unit is detached according to an embodiment of the present disclosure.

### DETAILED DESCRIPTION OF THE INVENTION

Hereinafter, specific embodiments for implementing the technical idea of the present disclosure will be described in detail with reference to the drawings.

In addition, in describing the present disclosure, when it is determined that a detailed description of related known configurations or functions may obscure the subject matter of the present disclosure, the detailed description thereof will be omitted.

Furthermore, it should be understood that when a component is referred to as being ‘connected’ or ‘supported’ by another component, it may be directly connected to or supported by the other component, but another component may exist in between.

The terminology used herein is for the purpose of describing particular embodiments only and is not intended to be limiting of the present disclosure. The singular forms are intended to include the plural forms as well, unless the context clearly indicates otherwise.

Furthermore, expressions such as upper, lower, side, etc., used in this specification are described based on the drawings, and it is noted in advance that they may be expressed differently if the direction of the corresponding object is changed. For the same reason, some components in the accompanying drawings are exaggerated, omitted, or schematically shown, and the size of each component does not entirely reflect the actual size.

Furthermore, terms including ordinal numbers such as first, second, etc., may be used to describe various components, but the corresponding components are not limited by these terms. These terms are only used to distinguish one component from another.

The meaning of “including” as used in the specification indicates the presence of stated features, regions, integers, operations, elements, and/or components, but does not preclude the presence or addition of one or more other features, regions, integers, operations, elements, components, and/or groups thereof.

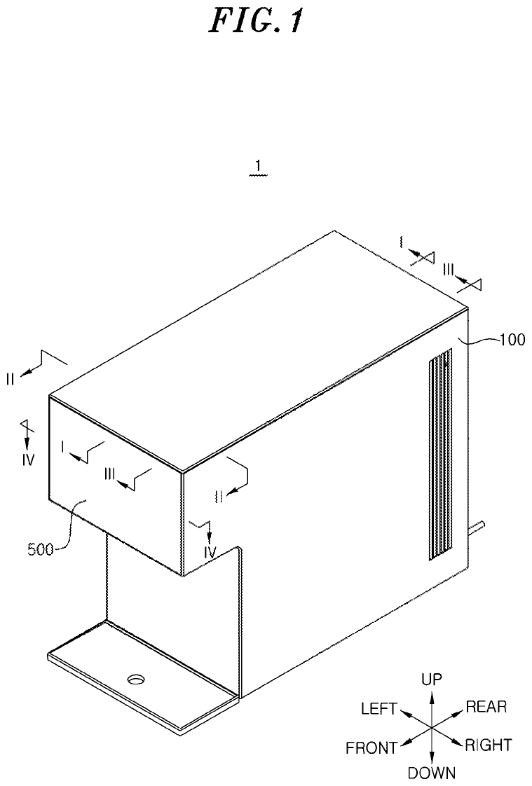

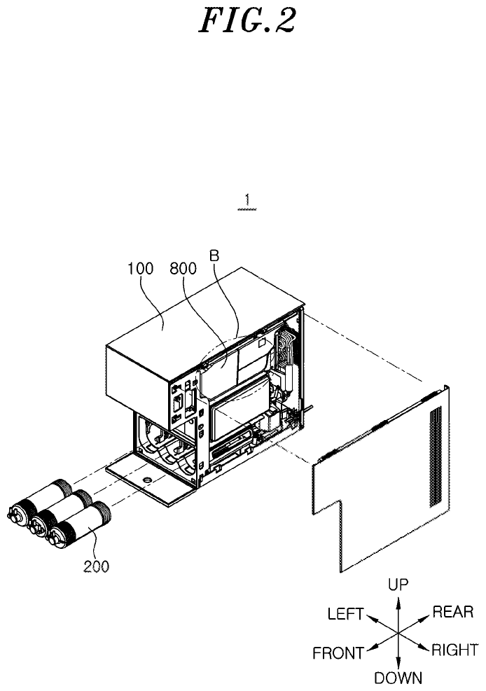

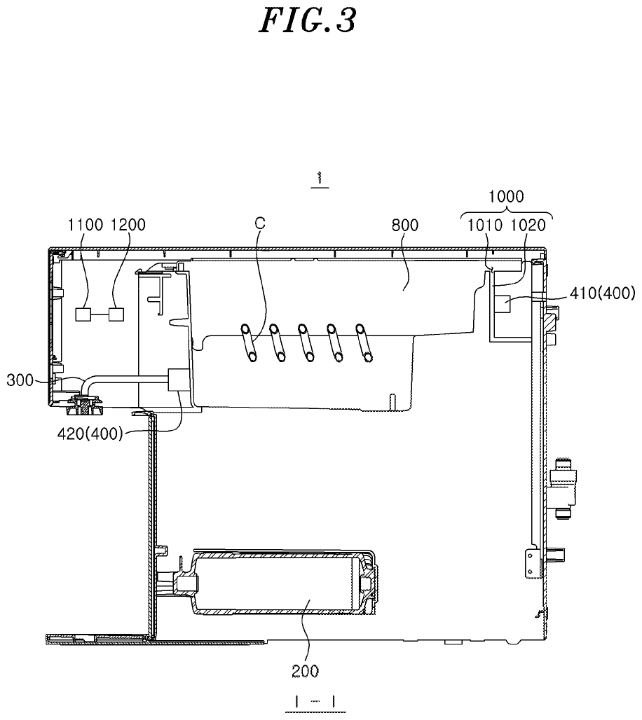

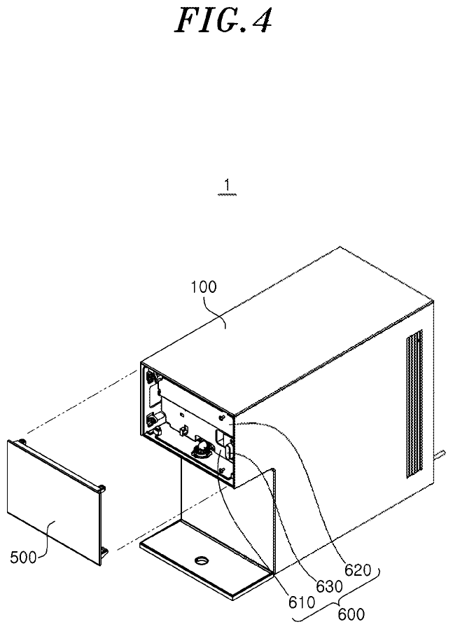

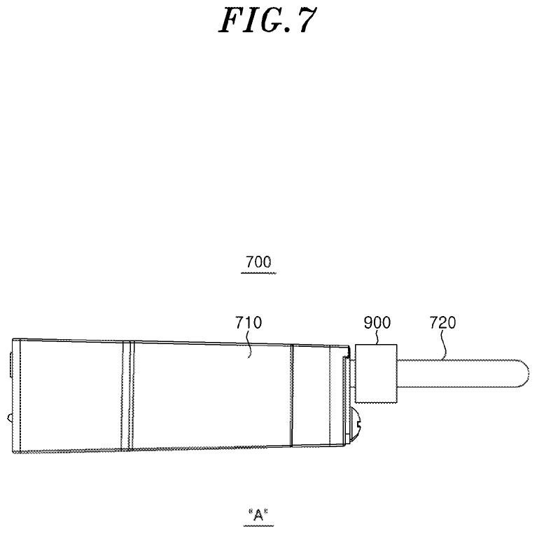

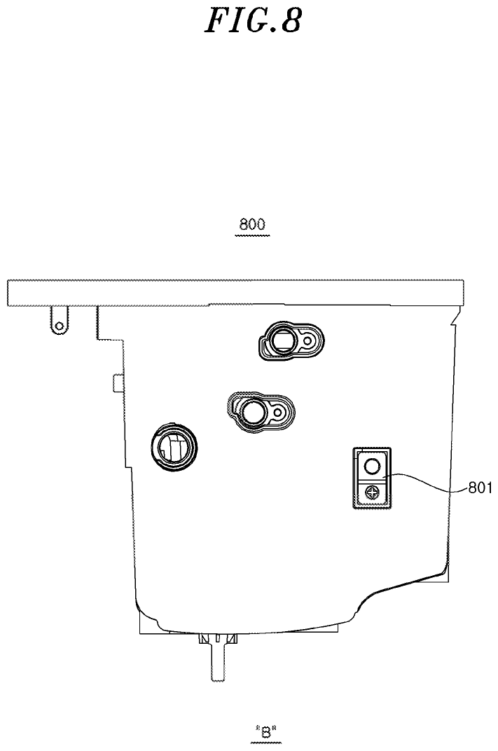

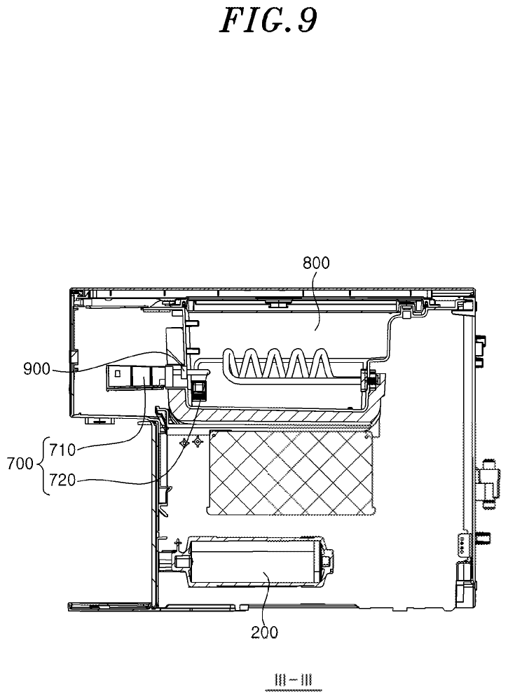

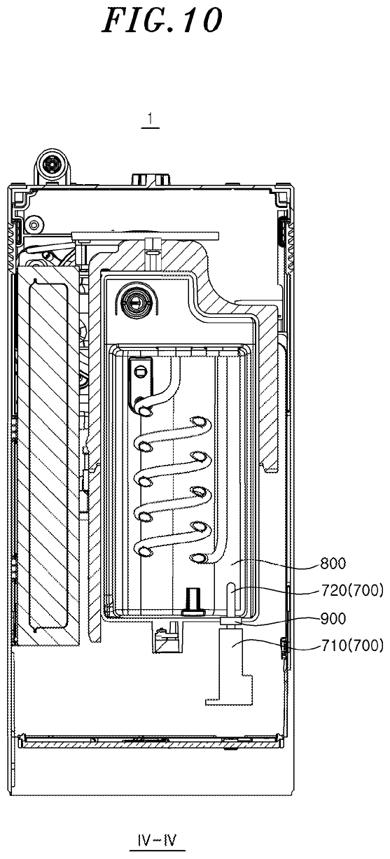

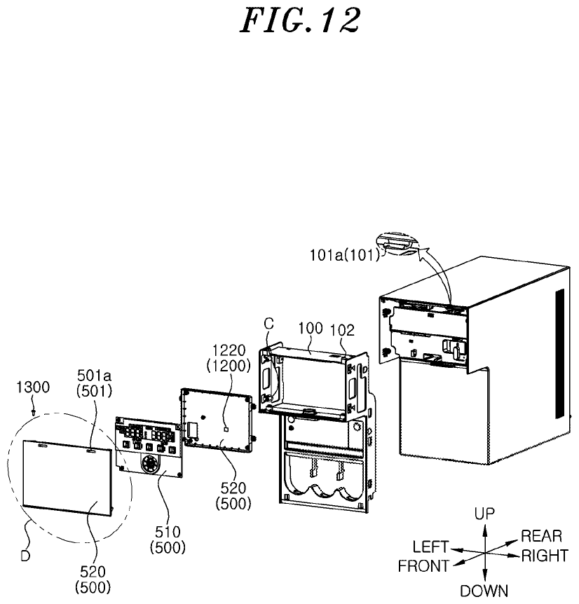

Hereinafter, a specific configuration of a water purifier 1 according to an embodiment of the present disclosure will be described with reference to FIGS. 1 to 14. The water purifier 1 according to an embodiment of the present disclosure may filter raw water to provide purified water to a user. Raw water is water having entered the water purifier 1 but not having passed through a filter, and purified water is water filtered through a purification device. The water purifier 1 may include a water purifier main body 100, a filter unit 200, a flow channel 300, a valve unit 400, a display unit 500, a body cover unit 600, a sensor unit 700, a reservoir 800, a sensor packing 900, an ambient air inlet passage 1000, a detachment detection sensor 1100, a controller 1200, and a screw 1300.

The water purifier main body 100 may support or cover at least one of the filter unit 200, the flow channel 300, and the valve unit 400. Such a water purifier main body 100 may include a frame and a housing. At least a part of the water purifier main body 100 may be opened or detached. In this case, the filter unit 200, the flow channel 300, the valve unit 400, the body cover unit 600, the sensor unit 700, and the reservoir 800, etc., may be exposed to the outside. A main body latching part 101 and a screw coupling part 102 may be provided on this main body 100.

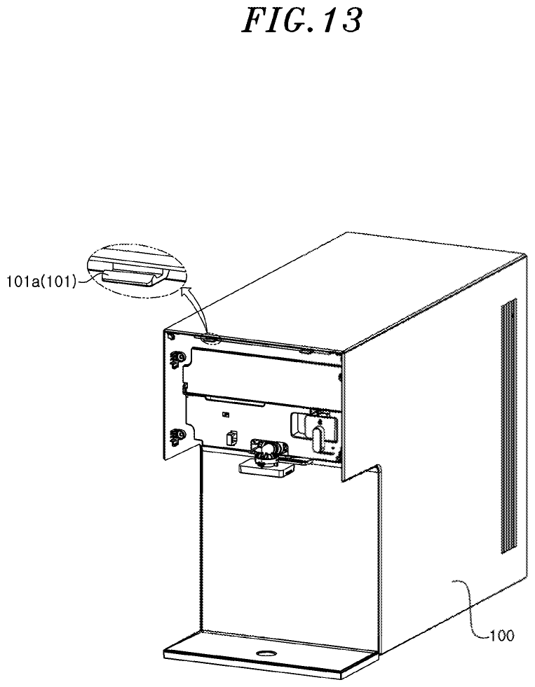

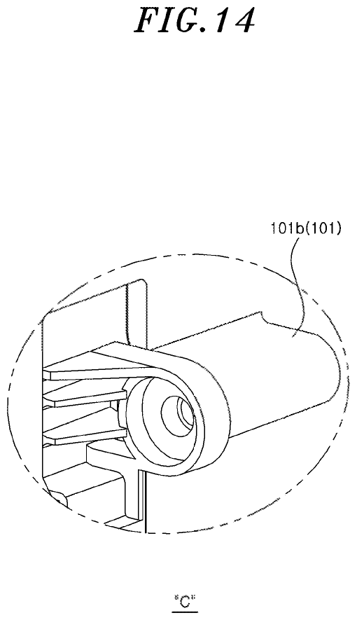

Hereinafter, the main body latching part 101 will be described with reference again to FIGS. 13 and 14. The main body latching part 101 may be formed to temporarily fasten the display unit 300 to the main body 100. The main body latching part 101 may include a first main body latching part 101a and a second main body latching part 101b.

The first main body latching part 101a may support a first display latching part 501a to be described later. A plurality of first main body latching parts 101a may be formed on an upper side of a front of the main body 100. The first main body latching part 101a may have a protrusion shape such as a hook which may be hooked by the first display latching part 501a. However, this is only an example, and the first main body latching part 101a may have a groove shape, and the first main body latching part 101a having a groove shape may also engage with the first display latching part 501a having a protrusion shape.

The second main body latching part 101b may support a second display latching part 501b to be described later. A plurality of second main body latching parts 101b may be provided on a side of the body cover unit 600 on the front of the main body 100. For example, the second main body latching part 101b may be provided on a side of the opening body cover part 620 and a side of the fixed body cover part 610. The second main body latching part 101b may have a hole shape into which the second display latching part 501b may be fastened. However, this is only an example, and the second main body latching part 101b may have a cylindrical shape, and the second main body latching part 101b having a cylindrical shape may also engage with the second display latching part 501b having a hole shape.

A screw 1300 may be fastened to the screw coupling part 102. When the screw 1300 is fastened to the screw coupling part 102, the display unit 500 and the water purifier main body 100 are screw-coupled and more firmly bound, and their relative movement may be restricted. The screw coupling part 102 may be formed on an upper portion of the water purifier main body 100. A thread part to which the screw 1300 may be coupled may be formed on the screw coupling part 102.

The filter unit 200 may filter raw water to provide purified water. Water filtered by the filter unit 200 is defined as purified water, and water not having passed through the filter unit 200 may be defined as raw water. The filter unit 200 may be replaced when its purification efficiency decreases due to long-term use. The filter unit 200 may be disposed, for example, below the valve unit 400.

The flow channel 300 may provide a passage through which at least one of raw water and purified water flows. Raw water may move to the filter unit 200 through the flow channel 300, be filtered by the filter unit 200, and the purified water may be discharged to the flow channel 300. Furthermore, the flow channel 300 may provide a passage through which purified water flows between the reservoir 800 and the filter unit 200. A plurality of flow channels 300 may be provided, and at least some ends of the plurality of flow channels 300 may be connected to the valve unit 400 and the filter unit 200.

The valve unit 400 may be selectively opened and closed to regulate the flow of at least one of raw water and purified water in the flow channel 300. The valve unit 400 may include one or more valves. The valve unit 400 may be connected to the flow channel 300 and operated to be opened and closed. The flow of raw water or purified water in the flow channel 300 may flow or be stopped by the valve unit 400. The valve unit 400 may include an ambient air valve 410 and an outlet valve 420.

The ambient air valve 410 may be opened and closed to allow air to enter and exit the reservoir 800. The ambient air valve 410 may regulate the entry and exit of air into the reservoir 800 by selectively opening and closing the ambient air inlet passage 1000. As the ambient air valve 410 is opened, air is permitted to flow into the reservoir 800, and as air flows into the reservoir 800, water inside the reservoir 800 may be smoothly discharged to the outside. When the ambient air valve 410 is closed, even if the outlet valve 420 is opened, the pressure inside the reservoir 800 is provided at or below atmospheric pressure, so due to the negative pressure of the air inside the reservoir 800, water within the reservoir 800 may not be discharged to the outside.

The outlet valve 420 may be selectively opened and closed to regulate the flow of at least one of raw water and purified water. The outlet valve 420 may regulate the discharge of water from the reservoir 800 by selectively opening and closing the outlet of the reservoir 800. When a user presses a purified water extraction button on the display unit 500, the ambient air valve 410 permits air to flow into the reservoir 800 so that water inside the reservoir 800 is discharged out of the reservoir 800, and the outlet valve 420 is also opened so that purified water may be dispensed to the user.

Although not shown, the valve unit 400 may include various valves for controlling the flow of water in addition to the ambient air valve 410 and the outlet valve 420. For example, the valve unit 400 may further include an inlet valve (not shown) for introducing purified water into the reservoir 800. The inlet valve (not shown) may regulate the inflow of water into the reservoir 800 by selectively opening and closing the inlet of the reservoir 800. When it is necessary to supply water to the inside of the reservoir 800 because purified water has been dispensed to a user, the inlet valve (not shown) may be opened. In this case, the ambient air valve 410 permits air inside the reservoir 800 to flow to the outside, so that water may smoothly flow into the reservoir 800.

The display unit 500 may display at least one piece of information about the water. For example, the display unit 500 may display at least one of a type of water discharged to the outside, a discharge amount of the water, and a temperature of the water. As a more detailed example, the presence or absence of an error, the necessity of filter replacement, the temperature of the purified water, and the type of purified water being discharged may be electronically displayed on the display unit 500. The display unit 500 may be integrally formed with a button, a touch panel, a dial, etc., to further perform a user input function. The display unit 500 may be integrally formed with a foremost side of the water purifier main body 100, and may be detachably supported by the water purifier main body 100. In other words, the display unit 500 may be in a detachable state in which the display unit 500 may be removed by a user's hand from the water purifier main body 100 including the housing, or in a fixed state in which the display unit 500 is fixed to the water purifier main body 100. The display unit 500 may be detached forward from the water purifier main body 100, or detached upward. Furthermore, the display unit 500 may be disposed on a foremost side of the water purifier main body 100. An edge (including at least one of an upper, lower, left, and right side edge) of this display unit 500 may be in contact with an edge of the housing of the water purifier main body 100. A display latching part 501 may be formed on the display unit 500, and the display unit 500 may include a display panel 510 and a display housing 520.

The display latching part 501 may engage with the main body latching part 101. The display latching part 501 may include a first display latching part 501a and a second display latching part 501b.

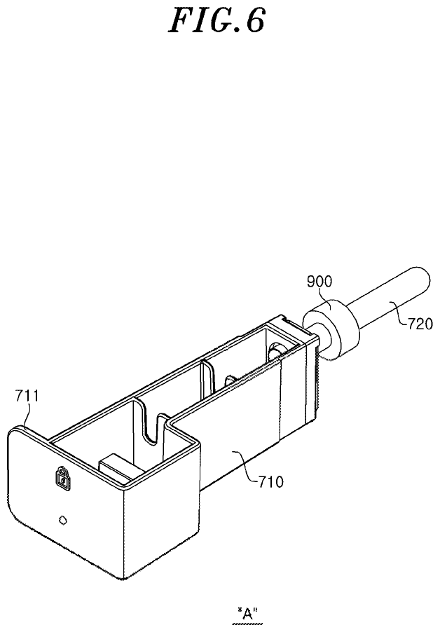

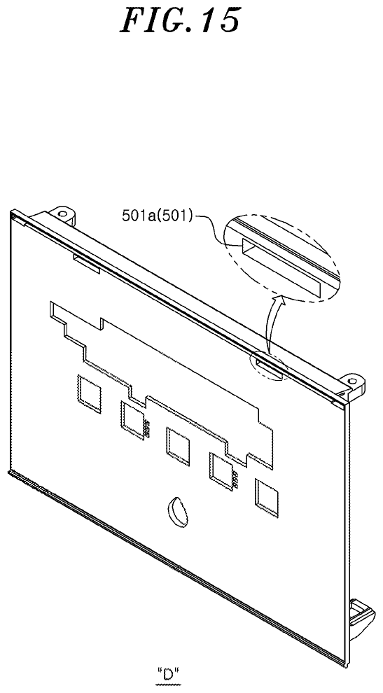

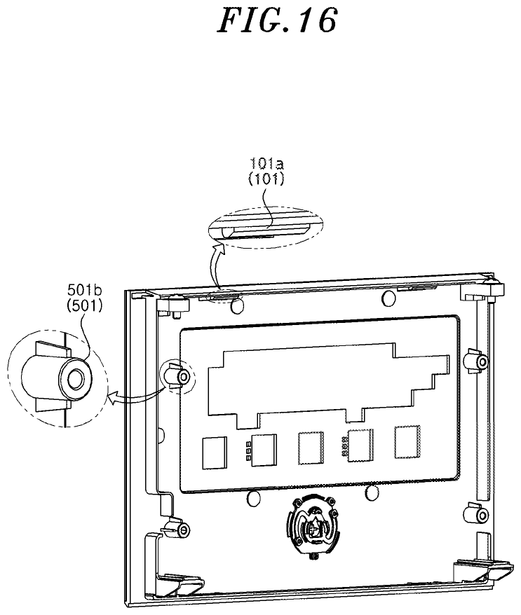

Hereinafter, the display latching part 501 will be described with reference to FIGS. 15 and 16. Referring again to FIG. 6, the first display latching part 501a may engage with the first main body latching part 101a. A plurality of first display latching parts 501a may be provided on an upper side of the display unit 500. The first display latching part 501a may, for example, have a groove shape. However, this is only an example, and the first display latching part 501a may have a protrusion shape, and the first display latching part 501a having a protrusion shape may also engage with the first main body latching part 101a having a protrusion shape. When the display latching part 501 is pressed from front to rear, the display latching part 501 may be moved relative to the water purifier main body 100 and engage with the main body latching part 101. When the display latching part 501 is pulled forward by a user, its engagement with the main body latching part 101 may be released by being moved relative to the water purifier main body 100.

The second display latching part 501b may engage with the second main body latching part 101b. A plurality of second display latching parts 501b may be provided on a side of the display unit 500. For example, a plurality of second display latching parts 501b may be provided respectively on an upper side and a lower side of the display unit 500. A front-rear length of a groove of the second display latching part 501b may be less than or equal to a front-rear length of a groove formed in the second main body latching part 101b.

The display panel 510 may display at least one piece of information about the water. For example, the display panel 510 may display at least one of a type of water discharged to the outside, a discharge amount of the water, and a temperature of the water. As a more detailed example, the presence or absence of an error, the necessity of filter replacement, the temperature of the purified water, and the type of purified water being discharged may be electronically displayed on the display panel 510. A groove part may be formed on the display panel 510 so as to be coupled with the display housing 520.

The display housing 520 may cover the display panel 510. The display housing 520 may cover the display panel 510 and a display controller 1220 so that the display panel 510 and a display controller 1220 are not exposed to the outside when the display unit 500 is detached from the water purifier main body 100. The display housing 520 may, for example, be disposed behind the display panel 510 and be disposed between the display unit 500 and the body cover unit 600. A display controller 1220, to be described later, may be disposed in the display housing 520. Furthermore, a molding part may be provided on an inner surface of the display housing 520 so that water is prevented from flowing into the display panel 510 when the display panel 510 is detached from the water purifier main body 100 by a user. In other words, a molding part may be provided between the display housing 520 and the display panel 510. A protrusion to which the display panel 510 may be coupled may be formed on the display housing 520. However, this is only an example, and the display housing 520 may have a groove shape, and the display panel 510 having a protrusion shape may also be coupled with the display housing 520 having a groove shape.

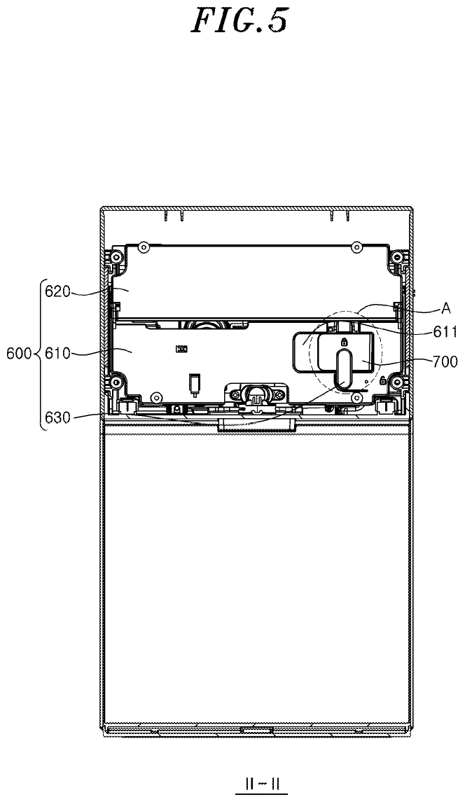

Referring again to FIG. 5, the body cover unit 600 may cover at least one of the filter unit 200, the flow channel 300, and the valve unit 400. The body cover unit 600 may be disposed inward of the water purifier main body 100 or the display unit 500. The body cover unit 600 may be exposed to the outside when a portion of the housing of the water purifier main body 100 on which the display unit 500 is formed is detached. This body cover unit 600 may be integrally formed with the water purifier main body 100, or may be formed as a separate body from the water purifier main body 100 and be detachable. The body cover unit 600 may include a fixed body cover part 610, an opening body cover part 620, and a lever 630.

The fixed body cover part 610 may be fixed to the water purifier main body 100 and support the sensor unit 700. This fixed body cover part 610 may be located below the opening body cover part 620. The fixed body cover part 610 may be located above a cock. A sensor body 611 may be formed in the fixed body cover part 610.

The sensor body 611 may provide a space for accommodating at least a portion of the sensor unit 700 when the sensor unit 700 is supported by the fixed body cover part 610. Based on a viewpoint looking in the direction in which the sensor unit 700 is inserted, a width in a left-right direction of the sensor body 611 may be greater than a width in a left-right direction of the sensor unit 700 in a state where the sensor unit 700 is inserted. The sensor body 611 may be formed on a right side of the fixed body cover part 610.

The opening body cover part 620 may be selectively opened to expose at least one of the filter unit 200, the flow channel 300, the valve unit 400, and the reservoir 800, which are disposed inside the opening body cover part 620, to the outside. This opening body cover part 620 may be rotatable relative to the fixed body cover part 610. Furthermore, the opening body cover part 620 may be disposed above the fixed body cover part 610. This opening body cover part 620 may be disposed inward of the display unit 500.

The lever 630 may selectively prevent the sensor unit 700 from being detached from the fixed body cover part 610. The lever 630 may be rotatable relative to the fixed body cover part 610. For example, when the lever 630 is rotated to one side, the lever 630 may interfere with the sensor unit 700 to prevent the sensor unit 700 from being detached from the fixed body cover part 610, and when the lever 630 is rotated to the other side, the lever 630 may not interfere with the sensor unit 700 and permit the sensor unit 700 to be detached from the fixed body cover part 610. As a more detailed example, the lever 630 may be oriented in an up-down direction when rotated to one side, and may be oriented in a horizontal direction when rotated to the other side. This lever 630 may have an elliptical shape close to a rectangle shape when viewed from the front.

Referring again to FIGS. 6 to 10, the sensor unit 700 may measure various types of state information in the reservoir 800. For example, the sensor unit 700 may measure the temperature of water stored in the reservoir 800, but is not limited thereto, and may measure at least one of various states of water such as water level and concentration. The sensor unit 700 may be detachably supported by the body cover unit 600. The sensor unit 700 may be inserted by moving in a direction perpendicular to the body cover unit 600. When the sensor unit 700 is supported by the body cover unit 600, the sensor unit 700 may be inserted into a sensor hole 801, to be described later, to sense the temperature of water, etc., in the reservoir 800. The sensor unit 700 may include a sensor holder 710 and a sensor 720.

The sensor holder 710 may support the sensor 720. The sensor holder 710 may be located on a front side of the sensor 720 in a state in which the sensor unit 700 is inserted into the sensor hole 801. The sensor holder 710 may be formed to extend in the direction in which the sensor unit 700 is inserted. A hook 711 may be formed on the sensor holder 710.

A user may place a finger on the hook 711. The user may place a hand on the hook 711 and pull the hook 711 forward to detach the sensor unit 700 from the sensor hole 801. The hook 711 may be formed on a front surface of the sensor holder 710.

The sensor 720 may measure state information of the water. For example, the sensor 720 may be a temperature sensor for measuring the temperature of the water. The sensor 720 may be disposed on a rear side of the sensor holder 710. One side of the sensor 720 may be coupled to the sensor holder 710, and the other side of the sensor 720 may be inserted through the sensor hole 801 to be disposed inside the reservoir 800. The sensor 720 may have a shape extending in the insertion direction.

The reservoir 800 may receive water from the outside and store the water therein. The reservoir 800 may have an inlet for receiving water from an external water supply source and an outlet for discharging the received water to the outside. A sensor hole 801 into which the sensor unit 700 may be inserted may be formed in the reservoir 800. Furthermore, an inlet hole through which water flows in and an outlet hole through which water is discharged may be formed in this reservoir 800. Furthermore, when the reservoir 800 is configured to accommodate a cooler C inside, a cooler hole for the cooler C to pass through may be formed in the reservoir 800.

This reservoir 800 may be provided as a sealed type. In other words, in the sealed reservoir 800, communication with the internal space and the external space may be blocked except through the inlet, the outlet, or the ambient air valve 410. In a state where the ambient air valve 410 and the outlet valve 420 are closed, the pressure inside the reservoir 800 is equal to or less than atmospheric pressure, so even if the sensor unit 700 is detached from the reservoir 800, the water accommodated inside the reservoir 800 may not leak to the outside. The reservoir 800 may be configured such that when the inlet valve (not shown) or the outlet valve 420 is open, an ambient air inlet passage 1000, to be described later, is opened by the ambient air valve 410, thereby permitting communication between the internal air and the external air.

The sensor hole 801 may be a space in the reservoir 800 into which the sensor unit 700 is inserted. The sensor hole 801 may be formed in a lower part of the reservoir 800. A diameter of the sensor hole 801 may be larger than a diameter of the temperature sensor 720. The sensor hole 801 may be formed to be long in the front-rear direction. This sensor hole 801 may be disposed below at least one of the inlet hole, the outlet hole, and the cooler hole.

The sensor packing 900 may provide packing to more effectively prevent water accommodated in the reservoir 800 from leaking through the sensor hole 801 when the sensor unit 700 is detached from the reservoir 800. The sensor packing 900 restricts water in the reservoir 800 from being discharged through the sensor hole 801 when the sensor unit 700 is detached from the body cover unit 600, and may be elastically deformed to allow the sensor 720 to be inserted through when the sensor unit 700 is inserted into the body cover unit 600. For example, the sensor packing 900 may be rubber. The sensor packing 900 may be a donut-shaped cylinder. The sensor packing 900 may be disposed closer to the sensor holder 710 than an end of the sensor 720 in the insertion direction in a state where the sensor unit 700 is coupled to the sensor hole 801. Furthermore, the sensor packing 900 may seal a minute gap between the sensor hole 801 and the sensor 720 to prevent the risk of leakage through the sensor hole 801.

As described above, since the reservoir 800 is provided as a sealed type, the sensor packing 900 may be omitted. In other words, even if the sensor packing 900 is not provided, air does not flow into the interior of the reservoir 800 when the ambient air valve 410 and the outlet valve 420 are closed, so the pressure inside the reservoir 800 is equal to or less than atmospheric pressure, and thus even if the sensor unit 700 is detached, the water inside the reservoir 800 may not leak to the outside.

The ambient air inlet passage 1000 may provide a space through which ambient air is introduced into the reservoir 800. The opening and closing of the ambient air inlet passage 1000 may be regulated by the ambient air valve 410. When the ambient air inlet passage 1000 is opened by the ambient air valve 410, ambient air is supplied to the reservoir 800, and when the ambient air inlet passage 1000 is closed by the ambient air valve 410, the supply of ambient air to the reservoir 800 may be blocked. The ambient air inlet passage 1000 may include an air inlet hole 1010 formed in the reservoir 800 and an air inlet passage 1020 communicating with the air inlet hole 1010.

The detachment detection sensor 1100 may detect at least one of the detachment of the display unit 500 from the water purifier main body 100 and the detachment of the water purifier main body 100. When the detachment detection sensor 1100 is detected at least one of the detachment of the display unit 500 from the water purifier main body 100 and the detachment of the water purifier main body 100, the ambient air valve 410 may block the ambient air inlet passage 1000 to block the inflow of ambient air into the reservoir 800.

The controller 1200 may control the opening and closing of the valve unit 400. The controller 1200 may open the ambient air valve 410 and the outlet valve 420 to allow raw water or purified water to flow out of the reservoir 800 when raw water or purified water needs to be dispensed. The controller 1200 may block the ambient air valve 410 to block the inflow of ambient air into the ambient air inlet passage 1000 when the detachment detection sensor 1100 is detected at least one of the detachment of the display unit 500 from the water purifier main body 100 and the detachment of the water purifier main body 100. The controller 1200 may be implemented by a computing device including a microprocessor, and its implementation method is obvious to those skilled in the art, so further detailed description will be omitted. The controller 1200 may include a main controller 1210 and a display controller 1220.

The main controller 1210 may be disposed within the water purifier main body 100 to control the valve unit so as to regulate the flow of raw water and purified water within the flow channel. The main controller 1210 may include a control port 1211.

The control port 1211 is connected to the main controller 1210 and may electrically connect the main controller 1210 to the outside. The control port 1211 may be taken out to the exterior through a space opened when the opening body cover part 620 is opened. In other words, the control port 1211 may be taken out by a user when the opening body cover part 620 is opened. When the user determines that there is an abnormality in the main controller 1210, the user may take out the control port 1211 and easily repair the main controller 1210.

The display controller 1220 may be disposed within the display housing 520 to control the display panel 510. The display controller 1220 may control the content displayed on the display panel 510. The display unit 500 may be easily detached by a user, and when the display unit 500 is detached, the display housing 520 may be easily exposed to the user. Therefore, the display controller 1220 may be easily repaired or replaced by the user without the need to disassemble the water purifier main body 100.

The screw 1300 may be a means for completely fastening the display unit 500 to the water purifier main body 100. In other words, the screw 1300 may be fastened to secure the display unit 500 to the water purifier main body 100 while the display latching part 501 is engaged with the main body latching part 101.

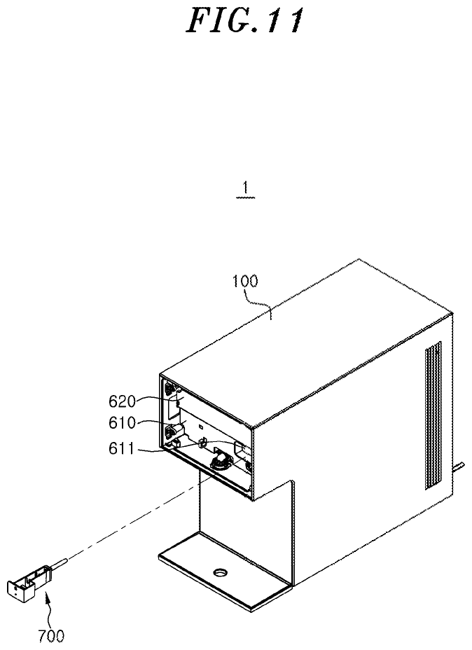

Hereinafter, the operation and effects of the water purifier 1 including the sensor unit 700 having the above-described configuration will be described with reference again to FIG. 11.

The water purifier 1 according to an embodiment of the present disclosure has an effect that the sensor unit 700 may be easily attached and detached by a user for easy self-maintenance. The user may detach the display unit 500 and then detach the sensor unit 700 coupled to the sensor body 611 formed on the fixed body cover part 610. When the user grabs the hook 711 formed on the front of the sensor unit 700 and pulls the hook 711 forward, the sensor unit 700 may be detached from the reservoir 800. After detaching the sensor unit 700, the user may replace the sensor 720 disposed on the rear side of the sensor unit 700 when necessary.

Furthermore, in the water purifier 1 according to an embodiment of the present disclosure, the sensor unit 700 may be easily coupled to the reservoir 800 by a user. The user may open the display unit 500 and then bring the sensor unit 700 toward the display unit 500 in a direction perpendicular to the display unit 500. Thereafter, the user may couple the sensor unit 700 to the sensor body 611 formed on the fixed body cover part 610. The sensor 720 of the coupled sensor unit 700 may be inserted into the reservoir 800 to measure factors such as the temperature of the water. Even when the sensor unit 700 is detached from the body cover unit 600 for replacement, water does not leak through the sensor hole 801 of the reservoir 800. This is because the reservoir 800 is provided as a sealed type, and the pressure inside the reservoir 800 is lower than atmospheric pressure when the user has not introduced air into the reservoir 800. Furthermore, the sensor packing 900 may seal the sensor hole 801 to prevent water inside the reservoir 800 from leaking. When the user presses a water dispensing button on the display unit 500, the ambient air valve 410 introduces air into the reservoir 800 to create an appropriate pressure state for dispensing, so that water may be dispensed to the outside of the reservoir 800.

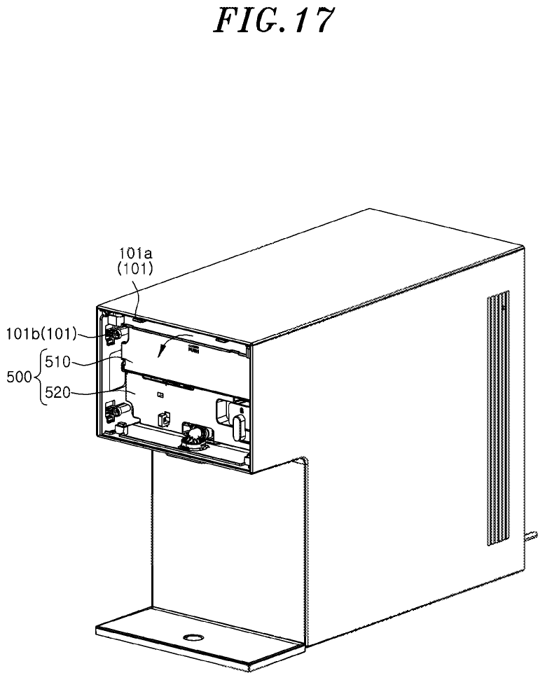

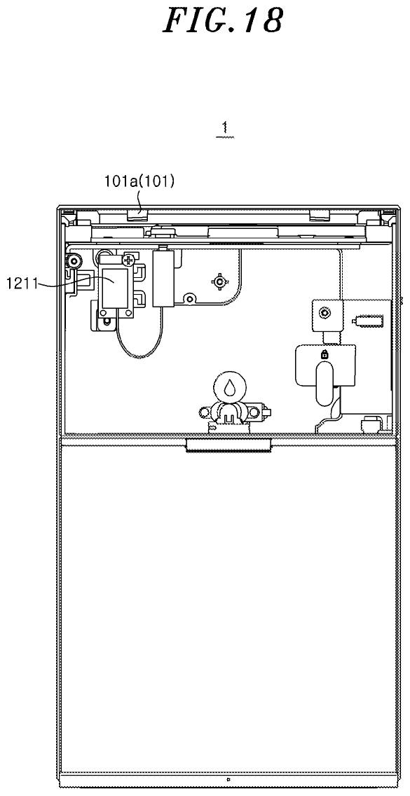

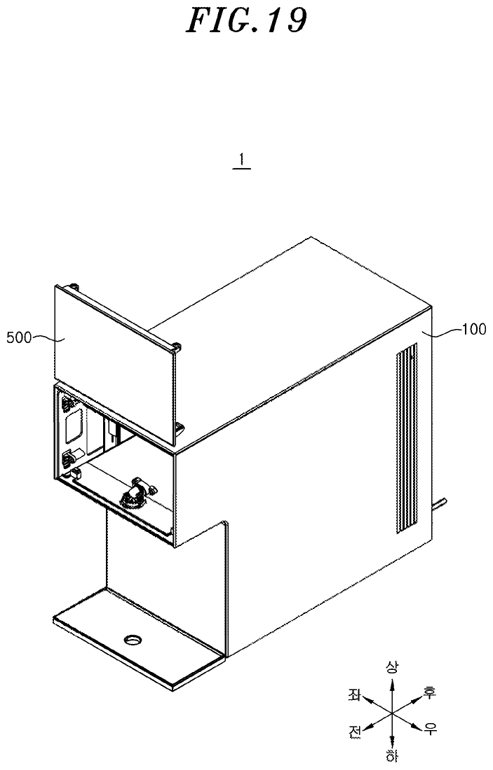

Hereinafter, the operation and effects of the display unit 500 having the above-described configuration will be described with reference to FIGS. 17 to 19. The display unit 500 may be coupled to or detached from the water purifier main body 100 by a user. Hereinafter, the process of coupling the display unit 500 to the water purifier main body 100 will be described. The display unit 500 is temporarily fastened to the water purifier main body 100 in a manner in which the display latching part 501 engages with the main body latching part 101, and may be completely fastened by fastening the screw 1300 to the screw coupling part 102. After the display unit 500 is placed in front of the water purifier main body 100 by the user, a plurality of first main body latching parts 101a having a protrusion shape may engage with a plurality of first display latching parts 501a having a groove shape. A plurality of second display latching parts 501b formed on the display housing 520 may engage with a plurality of second main body latching parts 101b. When all the display latching parts 501 are engaged with the main body latching parts 101, the screw 1300 may be fastened to the screw coupling part 102. By fastening the display unit 500 to the water purifier main body 100 using the screw 1300, the display unit 500 may be completely coupled to the water purifier main body 100.

Hereinafter, the process of detaching the display unit 500 from the water purifier main body 100 will be described. When detaching the display unit 500, the display unit 500may be detached by removing the screw 1300 from the screw coupling part 102 and releasing the engagement of the latching parts. The user may release the engagement by first removing the screw 1300 from the screw coupling part 102 and then pulling the display unit 500 forward. When the display unit 500 is pulled forward, the first main body latching part 101a is detached from the first display latching part 501a, and the second main body latching part 101b may be detached from the second display latching part 501b.

As the display unit 500 is easily detached by the user, repair of the main controller 1210 be easily performed by the control port 1211 that is taken out, and repair or replacement of the display controller 1220 disposed in the display housing 520 may be possible. Therefore, the user has the advantage in that, in the case of a simple malfunction, necessary repairs and simple part replacements may be performed by the user without a home visit from a service technician.

Although the embodiments of the present disclosure have been described as specific embodiments, they are merely examples, and the present disclosure is not limited thereto, and should be interpreted as having the broadest scope according to the technical idea disclosed in the present specification. A person skilled in the art may implement patterns of shapes not specified by combining/substituting the disclosed embodiments, but this also does not depart from the scope of the present disclosure. In addition, a person skilled in the art may easily change or modify the disclosed embodiments based on this specification, and it is clear that such changes or modifications also fall within the scope of the present disclosure.

What is claimed is:

1. A water purifier, comprising:
a water purifier main body configured such that at least a part thereof is opened;
a filter unit for filtering raw water to provide purified water;
a flow channel providing a passage through which the raw water and the purified water flow;
a valve unit comprising at least one valve module that is selectively opened and closed to regulate a flow of the raw water and the purified water;
a sensor unit for measuring state information of water and disposed within the water purifier main body;
a reservoir in which an inlet for receiving water from an external water supply source, an outlet for discharging the received water to an outside, and a sensor hole into which the sensor unit is insertable are formed; and
an ambient air inlet passage providing a path for ambient air to flow into the reservoir,
wherein the valve unit comprises an ambient air valve for selectively opening and closing the ambient air inlet passage, and
wherein when at least part of the water purifier main body is opened such that the sensor unit is exposed, the ambient air inlet passage is closed by the ambient air valve to prevent internal air from directly communicating with external air.

2. The water purifier of claim 1, further comprising:
a body cover unit covering at least one of the filter unit, the flow channel, and the valve unit,
wherein the sensor unit is detachably supported by the body cover unit.

3. The water purifier of claim 2, further comprising:
a display unit displaying at least one of a type of water discharged to the outside, a amount of the discharged water, and a temperature of the discharged water, and detachably supported by the water purifier main body;
a detachment detection sensor detecting at least one of a detachment of the display unit from the water purifier main body and at least the part of the water purifier main body to be opened; and
a controller controlling opening and closing of the valve unit,
wherein the controller, when the detachment of the display unit from the water purifier main body or at least the part of the water purifier main body is detected to be opened by the detachment detection sensor, closes the ambient air valve to prevent an ambient air from flowing into the reservoir through the ambient air inlet passage.

4. The water purifier of claim 1, wherein the sensor unit comprises:
a temperature sensor measuring a temperature of the water; and
a sensor holder for supporting the temperature sensor,
wherein a hook configured to receive a user's finger is formed on the sensor holder.

5. The water purifier of claim 2, further comprising:
a sensor packing disposed in the sensor hole,
wherein the sensor unit, when supported by the body cover unit, is inserted into the sensor hole to sense a temperature of water in the reservoir, and
wherein the sensor packing restricts water in the reservoir from being discharged through the sensor hole when the sensor unit is detached from the body cover unit.

6. The water purifier of claim 2, wherein the body cover unit comprises:
a fixed body cover part fixed to the water purifier main body;
an opening body cover part rotatable with respect to the fixed body cover part; and
a lever selectively preventing the sensor unit from being detached from the fixed body cover part,
wherein a sensor body, defining a space for accommodating at least a portion of the sensor unit when the sensor unit is supported, is formed in the fixed body cover part.

7. The water purifier of claim 6, wherein the lever, when disposed in an up-down direction, prevents the sensor unit from being detached from the fixed body cover part.

8. The water purifier of claim 1, wherein the valve unit further comprises an inlet valve for selectively opening and closing the inlet and an outlet valve for selectively opening and closing the outlet, and
wherein the reservoir is configured such that when the inlet valve or the outlet valve is opened, the ambient air inlet passage is opened by the ambient air valve to allow internal air to communicate with external air.

9. The water purifier of claim 1, further comprising a display unit displaying at least one of a type of water discharged to an outside, an amount of the discharged water, and a temperature of the discharged water, and detachably supported by the water purifier main body.

10. The water purifier of claim 9, further comprising a screw for securing the display unit to the water purifier main body,
wherein a main body latching part is formed on the water purifier main body,
wherein a display latching part engaging with the main body latching part is formed on the display unit, and
wherein the screw is fastened to secure the display unit to the water purifier main body while the display latching part is engaged with the main body latching part.

11. The water purifier of claim 9, further comprising:
a controller controlling at least one of the valve unit and the display unit; and
a body cover unit disposed inward of the display unit to cover at least one of the flow channel, the valve unit, and the controller,
wherein the body cover unit is exposed to the outside when the display unit is detached from the housing of the water purified main body.

12. The water purifier of claim 11, wherein the body cover unit comprises:
a fixed body cover part fixed to the water purifier main body; and
an opening body cover part disposed inward of the display unit and rotatable with respect to the fixed body cover part to expose at least one of the flow channel, the valve unit, and the controller to the outside.

13. The water purifier of claim 12, wherein the display unit comprises:
a display panel for displaying at least one of the type of water discharged to the outside, the amount of the discharged water, and the temperature of the discharged water; and
a display housing covering the display panel,
wherein the controller comprises:
a main controller disposed within the water purifier main body to control the valve unit to regulate a flow of the raw water and the purified water within the flow channel; and
a display controller disposed within the display housing to control the display panel, and
wherein the display housing covers the display panel and the display controller such that the display panel and the display controller are not exposed to the outside when the display unit is detached from the water purifier main body.

14. The water purifier of claim 13, wherein a molding part is provided on an inner surface of the display housing to prevent water from flowing into the display panel when the display unit is detached from the water purifier main body.

15. The water purifier of claim 12, wherein the controller comprises:
a main controller disposed within the water purifier main body to control the valve unit to regulate a flow of the raw water and the purified water within the flow channel; and
a control port connected to the main controller and arranged to electrically connect the main controller with the outside,
wherein the control port is removable to the outside through a space opened when the opening body cover part is opened.
